(19) United States
(12) Patent Application Publication
(10) Pub. No.: US 2023/0316262 A1
(43) Pub. Date: Oct. 5, 2023

(54) Fungible and Non-Fungible Tokens with Authenticity: Systems and Methods for Secure Funding and Fundraising for Businesses

(71) Applicant: Duy Khuong, Paris (FR)

(72) Inventor: Duy Khuong, Paris (FR)

(21) Appl. No.: 18/192,655

(22) Filed: Mar. 30, 2023

Related U.S. Application Data
(60) Provisional application No. 63/326,842, filed on Apr. 2, 2022.
(60) Provisional application No. 63/324,869, filed on Mar. 29, 2022.
(60) Provisional application No. 63/346,893, filed on May 29, 2022.

(51) Int. Cl. G06Q 20/36; G06Q 20/38; G06Q 20/40; G06Q 20/42; G06Q 30/0279; G06Q 40/06; G06Q 20/10

(52) U.S. Cl. CPC G06Q 20/3672; G06Q 20/389; G06Q 20/3678; G06Q 20/4014; G06Q 20/38215; G06Q 20/42; G06Q 20/3827; G06Q 30/0279; G06Q 40/06; G06Q 20/10

(57) ABSTRACT

An exemplary embodiment comprises fungible tokens with authenticity, namely Krypto coins (38), one non-fungible token with authenticity, namely business identification (BID) token (36), at least one crypto wallet (22) owned by a business owner of a business, and at least one business registry record (53) managed by a business registration authority. The Krypto coin (38) contains a unique identifier: the BID token's token address (36). The BID token (36) contains an identification hash, which uniquely represents the business identity, and a registrar address which points to the registration authority. The registration authority is the one who has confirmed the real-life identity of the business owner, the legally registered information of the business entity, and the legitimate ownership of the owner over the business and has created the registry record (53) on a blockchain. By looking for the existence of the business registry record (53) on the blockchain, investors can verify the authenticity of the Krypto coins before investing in the business, and the business owner can offer Krypto coins to investors for fundraising with more credibility and trust. Details of funding and fundraising processes with Krypto coins are discussed. Other embodiments are described and shown.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application claims the benefit of provisional patent applications Ser. No. 63/324,869, filed 2022 Mar. 29; Ser. No. 63/326,842, filed 2022 Apr. 2; and Ser. No. 63/346,893, filed 2022 May 29 by the present inventor, which are incorporated by reference in their entirety.

### BACKGROUND OF THE INVENTION

Most fungible tokens nowadays are based on standards like Ethereum Request for Comments-20 (ERC-20), which provides no authenticity. Everyone can create and distribute new tokens and call them by any name. Some bad actors intentionally named their tokens with the names of public companies, like Amazon and Tesla (names such as Amazon Token and Tesla Token), which misled the public and lured inexperienced investors for their money.

FIG. 1A illustrates a typical scenario where scammers use an Initial Coin Offering (ICO) to fool investors into giving them money in exchange for some coins that have no value.

An investor 14 is interested in business 18 (say, Awesome, Inc.) and wants to invest in this business. Investor 14 has heard that there is an upcoming ICO where freshly minted coins 38′ are being offered to early investors. All related information is on a website (say, “ico.awesome-inc.com”), including the price of the coin and the address of a wallet 22′, which the investor needs to send their money (e.g., cryptocurrencies, such as ETH).

The information on the website looks authentic; the name of the coin looks authentic (e.g., “Awesome Token”); the plan and projection look impressive and promising; all seem to be a good deal. Investor 14 then sends their money to the address of wallet 22′. He may or may not receive some coins 38′, as promised by the website.

However, as soon as it turns out, coin 38′ has no value. It is a fake coin, and wallet 22′ is a fake wallet. There are no links between the coin 38′ and wallet 22′, with the real business 18. The fake owner 22′ (scammer) used an unprotected ICO mechanism to fool investor 14. Investor 14 has exchanged real money (e.g., strong cryptocurrencies such as ETH) for some “coins” whose value is near zero.

Currently, fungible tokens (like coin 38′) have no authenticity. Furthermore, this kind of unprotected ICOs harms the investors and threatens the healthy development of crypto and blockchain.

Some investors may not be naïve like the one in the above example; they may try to research, look for all available information online and offline, and connect the pieces carefully before deciding to invest. They may be able to reduce some of the risks and avoid some scams. However, scammers, like all other kinds of criminals, are also clever; they keep improving their methods and tactics with increasingly sophisticated campaigns.

To avoid the risks of being scammed in online financial activities based on blockchain, we should not rely only on the skills and experiences of particular investors. We need a systematic and scientifically-proven mechanism that helps even inexperienced investors recognize which coins are fake, which coins are legitimate, and when it is safe to invest. We must find a way to introduce authenticity to the coins—to the fungible tokens.

### SUMMARY OF THE INVENTION

The following summary is provided as a way to simplify and help the reader better understand the overall idea of the described technology. It is not to be construed as a limitation of the scope of this disclosure.

A fungible token with authenticity is a fungible token that has an added property which is a unique value that represents and is used to identify a legally recognized business entity.

This unique value is universally unique and is considered a digital identification (ID) of the business. There are no two businesses that share the same digital ID.

This digital ID is the token address of an identification (ID) token that represents the business. The ID token is a non-fungible token with authenticity.

The owner of the fungible token (or coin) is the owner of the business.

The owner of the coin (and the business) can create (or mint) new coins, and the owner is authorized to offer coins to other investors (in events such as Initial Coin Offerings or fundraisings).

In such events (ICOs, fundraisings, etc.), transactions can be made with (one of) the wallet(s) of the owner.

Investors can verify the legitimacy of the owner and his ownership over the business by looking for a registry record permanently stored on the blockchain.

This record, which can be considered a certificate of ownership, matches the owner's wallet address with the business' digital ID.

This on-chain record is a hash value computed from 2 values: one is the wallet address of the owner, and the other one is the digital ID of the business.

Every on-chain record has a different value and represents a different pair of wallet addresses and its corresponding digital ID of the business.

The computation can be based on one of the standard hash algorithms or any computation that is deterministic and irreversible: Deterministic to make sure that the same inputs provide exactly the same output and there are no two different inputs provide the same output; Irreversible to make sure that inputs cannot be recovered from knowing the output.

The process of creating the on-chain record (the first time, when there's no such record yet) is called a business ID registration process.

In the registration process, the owner (the one who claims to be the owner) of the business has to provide all necessary evidence (usually government-issued documents) to prove his ownership of the business.

Once all the evidence has been verified by a trusted party, a record will be created and permanently stored on the blockchain by that party or another dedicated party called a registrar.

A fungible token (or a coin) can be minted by the registered (or authorized) owner of the business whose wallet address has been recorded on-chain with the business's digital ID.

When the owner wants to call for funding from outside investors (in events such as ICO or fundraising), he can use (one of) his authorized wallet(s), and transactions can be made with this (or these) wallet(s).

The owner can use more than one wallet, but all of these wallets need to be registered with the business' digital ID (in other words, there are records on the blockchain that certify the matches) in order to be used in the ICOs or fundraising events.

At each round of fundraising, the owner can specify which one of his registered wallets is the host of the round. The host is the wallet responsible for receiving funds and releasing coins. New coins will also be minted for this host.

### BRIEF DESCRIPTION OF DRAWINGS

FIG. 1A illustrates current issues with Initial Coin Offerings (ICOs);

FIG. 1B is an overview of our system for funding and fundraising;

FIG. 1C illustrates relationships between key components of the system;

FIG. 2 is a use case diagram for the system;

FIG. 3A is a block diagram of the system;

FIG. 3B illustrates the relationships of blocks in the diagram with the use cases;

FIG. 4A is class diagrams of Personal Identification (ID) token and Business ID token;

FIG. 4B is a class diagram of a Krypto coin;

FIG. 4C is part of a matching table between fields of identification information with a type of ID token;

FIG. 4D is an example of a metadata file for a PID token;

FIG. 4E is an example of a metadata file for a BID token;

FIG. 5A is a sequence diagram depicting the process of creating a personal ID token;

FIG. 5B is a sequence diagram depicting the process of registering a personal ID token;

FIG. 5C is a sequence diagram depicting the process of registering a business ID token;

FIG. 6A is a sequence diagram depicting the process of creating a new coin;

FIG. 7A is a sequence diagram depicting a funding process;

FIG. 7B is a sequence diagram depicting a fundraising process;

FIGS. 8-1A to 8-4B are screenshots of an exemplary smartphone app that interacts with the system.

### DRAWINGS—REFERENCE NUMERALS

A list of reference numerals used in the drawings:
10: User in general,
12: Business owner,
12′: Fake business owner,
14: Investor,
16: Public user,
18: Business, company,
20: Crypto wallet in general,
22: Crypto wallet of Business owner (Wallet B.O.),
22′: Crypto wallet of fake owner
22H: Host wallet
24: Crypto wallet of Investor (Wallet I),
25: Identification (ID) hash
26: ID type
27: token URI
28: registrar address
29: isIdentified( ) interface
30: Personal identification (ID) token in general,
32: Personal ID token of Business owner,
34: Personal ID token of Investor,
36: Business ID token,
38: Coin of business,
38′: Typical crypto coin
40: Personal ID creator smart contract (Creator P),
42: Business ID creator smart contract (Creator B),
48: Coin Creator smart contract,
50: Personal ID registrar smart contract (Registrar P),
51: Personal registry record of business owner,
52: Business ID registrar smart contract (Registrar B),
53: Business registry record of business.

### DETAILED DESCRIPTION OF THE INVENTION

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the spirit and scope of the disclosure.

### System Overview

The embodiments disclosed herein provide authenticity to fungible and non-fungible tokens that help prevent misleading information (or scams) in online financial activities and systems and methods for business owners to raise funding for their businesses, as well as for inexperienced investors to invest in the businesses they want, safely and more efficiently.

For example, before deciding to fund a business (by buying its fungible tokens or coins), the investor can: (1) Verify the authenticity of the coins to make sure they belong to the business the investor is trying to fund (thanks to the Fungible Tokens with Authenticity); and (2) Verify that the wallet address they are sending the fund to is one of the authorized owners of that business (by confirming the wallet holder's real-life identity with on-chain data, thanks to the Non-Fungible Tokens with Authenticity).

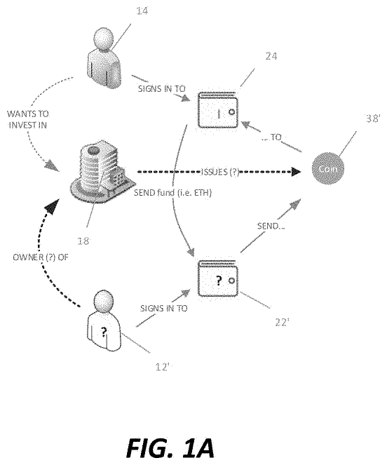

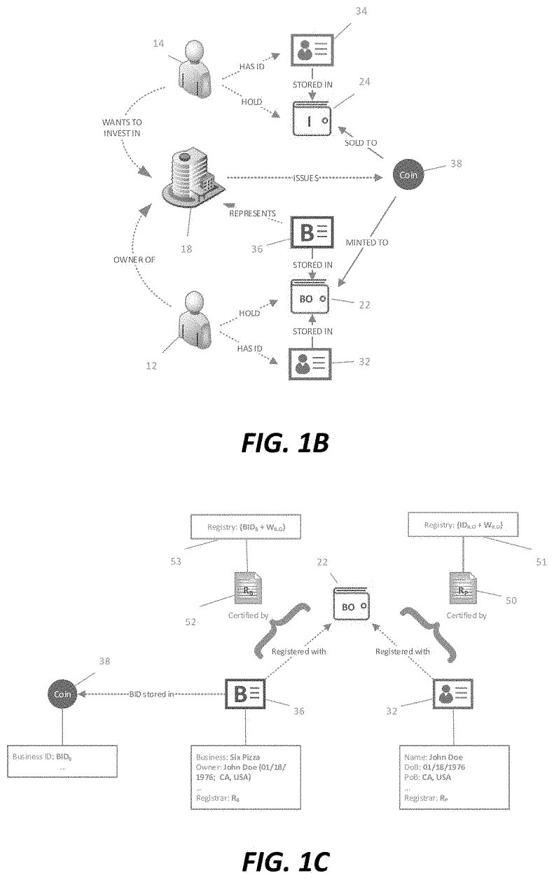

FIG. 1B illustrates one embodiment in its general context.

An investor 14 wants to invest in (fund) a business 18, which is owned by a business owner 12. The investor 14 can do that by buying a number of fungible tokens (or coins or crypto) 38 that were issued by business 18. These coins are initially minted in a wallet 22 that belongs to the owner 12. Wallet 22 is also holding a personal identification (ID) token 32 of owner 12 and a business identification (BID) token 36 that certifies the ownership of owner 12 over business 18.

The process of buying the coins (or funding, investing) is similar to a normal Initial Coin Offering (ICO) process but is different at the following points: Before buying the coin 38, the investor 14 can verify the authenticity of the coin and be sure that: (a) This coin is indeed a property (asset) of business 18 (in which he wants to invest in); (b) It was created by a legitimate owner of the business (which is the business owner 12); and (c) The wallet 22 that is distributing the coins belongs to the legitimate owner 12.

These objectives can be achieved by the application of the following key components: (1) ID token 32, which proves the real-life identity of the business owner 12; (2) BID token 36, which proves the legitimacy of their ownership over the business; (3) Krypto coin 38 which stores verified information regarding the business it represents; (4) Krypto wallets which handle the transactions; and (5) Registrars that verify and register ID tokens and BID tokens.

A platform that comprises some or all of these components and which coordinates the processes of funding and fundraising with the Krypto tokens is called a Krypto token platform.

(We use the prefix “Krypto” in front of our component names as a way to differentiate them from their state-of-the-art counterparts).

FIG. 1C is used, in addition to FIG. 1B, to illustrate the relationships between these key components.

A personal identification token (or ID token) 32 is a new kind of Non-Fungible Token (NFT) that has the authenticity to represent a real-life identity of a person. When an ID Token is created, it will be registered with a registration authority (or registrar) 50 by its owner. The registrar will confirm the person's identity (based on their provided legal documents) and keeps a record 51 that matches the ID token with the address of the wallet 22 that the person is using.

The ID token is discussed in detail in another patent application of mine, Ser. No. 18/091,118, filed 2022 Dec. 29, titled “Identification token, systems and methods for identification and identity verification.”

A business identification (BID) token 36 is an extended version of an ID token that represents a registered business with all of its registration information, including the name(s) of the owner(s). When a BID token 36 is created, it will be registered with a business registrar 52 by (one of) its owner(s). The registrar will confirm the person's real-life identity and the business's registry info (based on their provided evidence) and keeps a record 53 that matches the BID token 36 with the address of wallet 22 that the person is using.

By keeping registry records that verify the wallet address with the ID token and BID token, the registrars (50 and 52) guarantee that anyone that has access to wallet 22 is the same person that registered the tokens. In other words, he is the legitimate owner of the person's real-life identity and the business.

A Krypto coin 38 is an extended version of the standard Fungible token (based on Ethereum Request for Comment 20, ERC-20, in the current embodiment) with an added property to provide authenticity. This property is a Business ID which is the address of the BID token 36 that was created by the business owner 12 and verified by the registrar 52.

In some embodiments, the Krypto coin 38 may also have other properties, including but not limited to an authorized wallet address which is the address of the wallet 22; other information such as the number of funding rounds that have been created, current price, total capital raised, history of transactions, etc.

In our embodiment, the business ID information in the Krypto coin 38 is immutable. Once the coin has been created and minted, this information cannot be changed and always points to the same BID token. However, in some embodiments, this business ID information may also be changed later by (one of) the legitimate owner(s) in order to provide flexibility.

By reading the business ID information and other information if it existed, investor 14 can be certain that the Krypto coin 38 indeed belongs to the business that they want to invest in, and the authorized wallet 22 is the destination where they should transfer their fund to and receive the coins from.

Krypto wallet 22 is similar to a normal crypto wallet but has some advanced features that are specialized for ID tokens, BID tokens, and Krypto coins. Those features include but are not limited to automatically verifying with the registrars (50, 52) and displaying the verification statuses of the ID token 32 and the BID token 36 that are currently held in the wallet. When used by the business owner 12, it can automatically receive funds from and send coins to an investor in a funding round.

As mentioned earlier, registrars 50 and 52 are registration authorities that verify that wallet 22 is the authorized wallet of the ID and BID tokens by matching the address of each token with the address of wallet 22. These matching records are called registry records and are stored on the blockchain. The details of registrars and registry records are discussed in my patent application for ID tokens.

The Krypto token platform is a specialized platform where all of the above concepts are applied. This is the place to connect private businesses and their owners with potential investors. In the following section, we will discuss in detail all aspects of the platform.

### Kypto Token Platform

Krypto token platform is a set of applications, standards, and proposals to enhance the fundraising and funding processes (e.g., Initial Coin Offerings, etc.) to make them safer (for investors to invest), more effective (for business owners to raise funds) and more accessible to all. The improvements are even more beneficial for small individuals (investors as well as business owners) who do not yet have many capabilities and possibilities with current traditional processes.

The central component of the platform is an application called the Initial Coin Offering Platform (ICOP) app, which handles the processes that can be considered the improved version of the traditional ICO processes (we can call it “ICO 2.0”).

An “app” or “application,” as we shall use throughout this disclosure, can be a smart contract on a blockchain. However, this should not be construed as a limitation. It can also be computer software, a web app or a smartphone app, an interface or a protocol, or a combination thereof.

The platform is the place where a business owner (BO) can: (1) Issue Krypto coin (or coin); (2) List coin; and (3) Sell coin/Raise funds for their business; and an investor can: (1) View/Browse information about businesses, and (2) Buy coin/Invest/Fund.

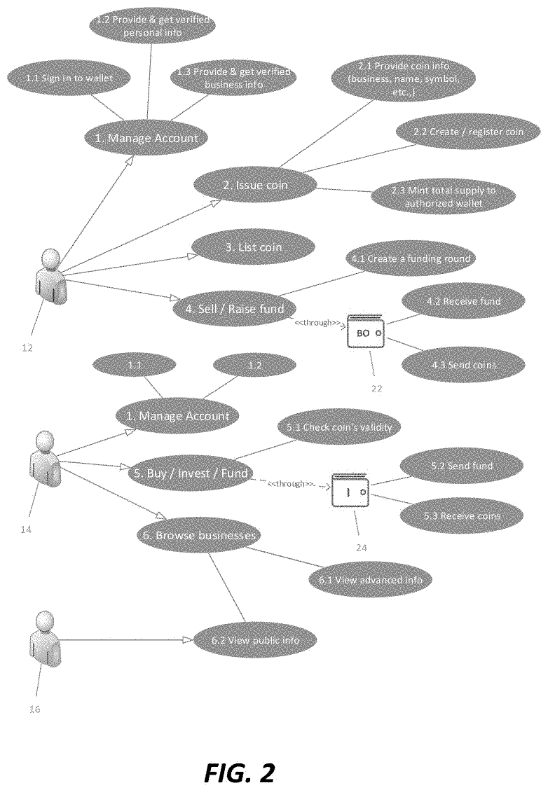

The overall use cases of the platform are illustrated in FIG. 2.

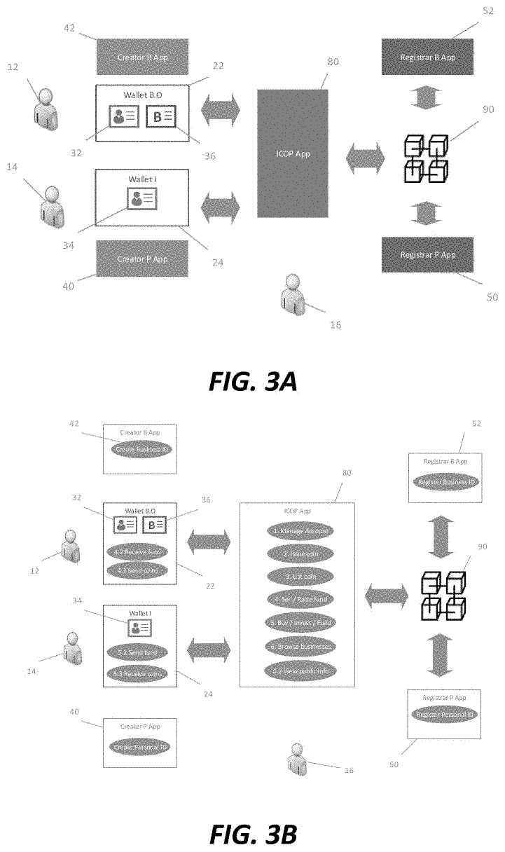

FIG. 3A is a block diagram of the platform. It illustrates the key components of the platform (that we described earlier) in relation to the ICOP app 80.

Business owner 12 uses wallet BO 22 to interact with ICOP app 80. In wallet 22, there is ID token 32 and BID token 36.

Investor 14 uses wallet I 24 to interact with ICOP app 80. In the wallet, 24 is ID token 34 of the investor.

The ID tokens 32 and 34 were created by Creator P app 40 and registered by Registrar P app 50. The BID token was created by Creator B app 42 and registered by Registrar B app 52. Those registrars create and manage registry records which are stored on blockchain 90.

A normal or public user 16 can access ICOP app 80 using any other interface, such as a web interface, without the need to use their own crypto wallet.

The use cases that each component of the platform handles can be understood by the illustration in FIG. 3B.

In the following sections, we will discuss in detail: The non-fungible tokens with authenticity (ID token and BID token) and the fungible token with authenticity (the Krypto coin).

### Identification Token

An identification token (ID token) is a kind of non-fungible token (NFT) on a blockchain that includes some new properties to represent an identity. That identity can be a personal identity (with details matching those on a passport, national ID card, etc.), a legally recognized business entity, or any other kind of real-life or virtual identity (e.g., a virtual identity such as a metaverse ID, virtual land residency card, etc.).

The type of the ID token is defined by an identification type (ID type), while the information the token represents is stored in a hashed value named identification hash (ID hash). In order to create an ID token, one should provide all fields of identification information (IDI) needed, which may vary depending on the ID type. The ID hash will be calculated based on this information, and its value will be saved permanently in the token.

After the ID token has been created with the identification information (e.g., of the person or the business), it will be associated with the owner's crypto wallet. The association is certified by a trusted party known as a registrar (or a registration authority). When the person needs to prove their identity, they just need to log in (or sign in) to the associated crypto wallet.

However, in order to be certified by the registrar, the person needs to provide the evidence (e.g., ID scans, government-issued documents, etc.) in the registration process to make sure that the individual currently accessing the wallet has the same identity as that indicated by the ID token. Once the registrar has confirmed the evidence, a registry record is created and stored permanently on the blockchain, which can be used for identity verification later.

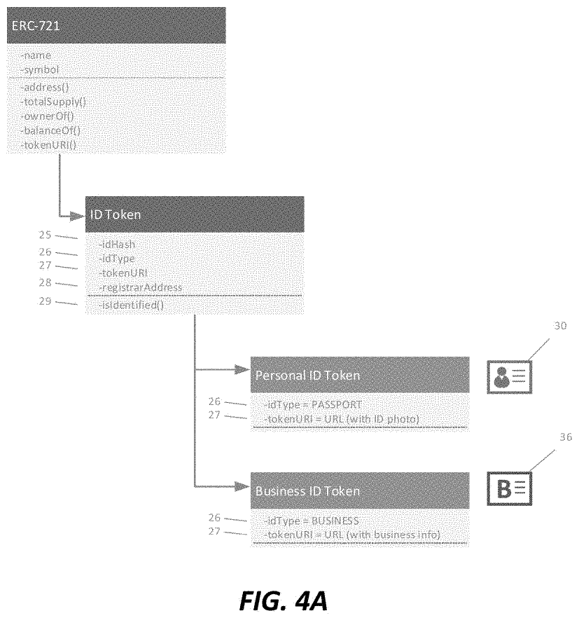

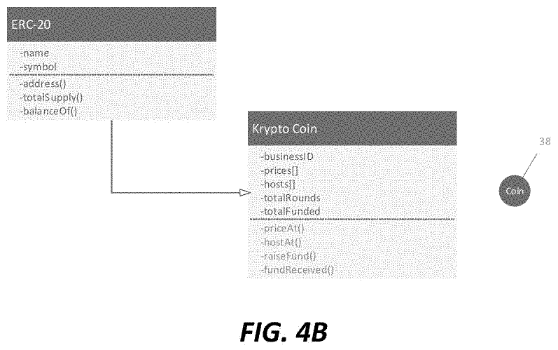

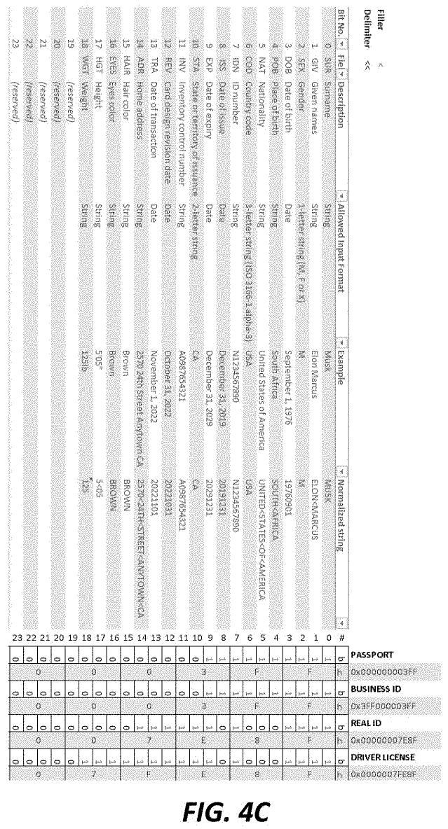

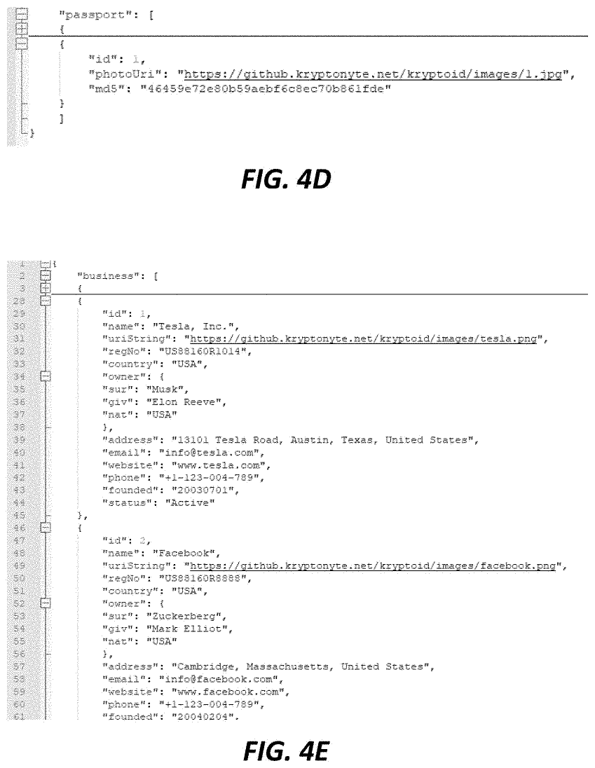

FIG. 4A shows a class diagram of an ID token (and class diagrams of a Personal and a Business ID token, which will be discussed later). It is an extended class of the standard Ethereum Request for Comments 721 (ERC-721) deployed on the Ethereum blockchain.

Although the exemplary embodiment described herein employs ERC-721 and the Ethereum blockchain, it should be appreciated that other standards, like ERC-1155 or similar, on another private or public blockchain, might also be used as a base for implementing the ID token.

In the displayed embodiment (FIG. 4A), while the ID token 32 keeps the original properties such as name, symbol, and token URI 27 of the ERC-721 standard, it has some new properties, which are: idHash 25, idType 26, registrarAddress 28 and an interface isIdentified( ) 29.

The type of the ID token 32 is defined by its type (ID type) 26, while the information it represents is stored in idHash (ID hash) 25. When the ID token 32 is created, apart from these two values, a registrar address (registrar address) 28 also needs to be specified. The registrar address 28 is the address of a registrar smart contract or of a crypto wallet that belongs to a registration authority. This registration authority is the agent that confirms and validates all of the evidence submitted by the user in the ID token registration process.

In the displayed embodiment, a token URI 27, a property from the standard, will also be assigned a value. This value is the location of the metadata file of the ID token 32. This metadata file contains some publicly accessible and human-readable information about the ID token.

The public interface isIdentified( ) 29 is the method to check whether the raw inputs (a person's identity information) match the hash value stored in the token (ID hash 25). Because only the same input can produce the same hash, this method is used to confirm again whether the person can identify themselves and prove that they are the same individual that created the ID token 32.

The ID token 32 is created (and managed) by a smart contract called a creator smart contract, or creator P 40. It should be appreciated by those skilled in the art that the definitions for all the properties and method(s) of an ID token explained above are, in fact, written in the creator P 40 smart contract. When the creator P 40 is deployed on the blockchain, it can be used not only to create a new token but also to read the properties of a particular token or to verify the information the token represents (i.e., the identity) by calling the interface isIdentified( ).

### Personal ID Token

Personal ID (PID) tokens are ID tokens whose idType 26 is a type of personal ID (e.g., passport, national ID card, driver's license, etc.). Personal ID tokens are used to verify real-life personal identities. Each deployed ID token smart contract will manage a certain type of PID. This type is specified when the contract is deployed on the blockchain.

For example, FIG. 4A illustrates a Personal ID token 30 with idType 26 as PASSPORT.

Type PASSPORT (equals 0x03FF) is a predefined number defining what type of identification information the PID stores. Similar to real-life counterparts, different types of PIDs will contain different kinds of information. For example, in a driver's license, there may be information about the owner's eyes color, but this information is not represented in a standard passport. The matching between the type of PID token and the information it represents is described in the table in FIG. 4C. By converting this number to its hexadecimal form, referring to the matching table in FIG. 4C, one will know each field of personal identification information is stored in the PID token.

For example, with the type PASSPORT (0x03FF or b'1111111111), one will know that there are ten fields of information (represented by 10 number 1's in the binary form) stored in the PID: Surname (SUR), GIV (Given names), Gender (SEX), Date of birth (DOB), Place of birth (POB), Nationality (NAT), Country code (COD), ID number (IDN), Date of issue (ISS), and Date of expiry (EXP).

In the embodiment being discussed, we use type PASSPORT for the PID (as seen in FIG. 4A). However, in some embodiments, other types of PID can be used. For example, it can be DRIVER_LICENSE (0x7FE8F) or REAL ID (0x7E8F, according to FIG. 4C), etc.

Similar to other types of ID tokens, when a new PID token is created, its tokenURI 27 will be assigned a value wherein the value is an URL to a metadata file stored on the internet. However, with PID tokens, there is one specific piece of information stored in the metadata file, which is the location where the ID photo of the person is stored.

FIG. 4D is an example of a metadata file for a PID token wherein the path (or URI) of the ID photo is specified in the key “photoUri” of the JSON metadata.

### Business ID Token

Business ID (BID) tokens are ID tokens with its type (idType 26), a type of business entity (BUSINESS), and its tokenURI 27 points to the location of a metadata file where the public information of the business is stored.

FIG. 4A is a class diagram of a BID token 36. It is an extended class of the ID token class.

Similar to PID tokens (or other kinds of ID tokens), the type BUSINESS is a predefined number that defines what kind of information the BID token stores. More precisely, it defines what fields of information are used to calculate the hash 25 stored in the BID token 36.

According to the table in FIG. 4C, type BUSINESS equals 0x3FF000003FF, which means the following information is represented by (and is used to calculate the idHash 25 of) the BID:

The business-related information: Country (COU), Registry number (REG), Business Name (BUS), Date of foundation (FOU), Status (STS), Address (ADD), Email (EMA), Website (WEB), Phone (TEL), Logo URL (LOG); and the personal information of the business owner: Surname (SUR), GIV (Given names), Gender (SEX), Date of birth (DOB), Place of birth (POB), Nationality (NAT), Country code (COD), ID number (IDN), Date of issue (ISS), and Date of expiry (EXP).

In some embodiments, other fields of information for the business and its owner may be used. In such cases, the idType 26 for the BID 36 may have a different value.

FIG. 4E is an example of a metadata file of a business whose URL is the tokenURI 27.

In the embodiment being discussed, not all information that the BID represents (those that were used to calculate the idHash 25) is also written in the metadata file, but only public information, such as The business name, its registered country, its owner's name, and nationality, etc. as can be seen in the FIG. 4E.

### Kypto Coin

Krypto coin 38 is a new kind of fungible token that has a special feature, or property, which is authenticity. Krypto coins are issued by legitimate and legally recognized businesses. They are created by the legitimate owners of the businesses. Embedded within the coins is specific information about the business that helps any users (i.e., investors) verify if they are legitimate and can be used safely for their transactions. Additionally, the coins also tell the investors which is the authorized destination, or the address of an authorized wallet, that the investors should transfer their funds. Other financial information is also associated with the coins that help facilitate funding and fundraising activities.

FIG. 4B is a class diagram of Krypto coin 38. It is based on the standard Ethereum Request for Comments 20 (ERC-20) class.

Although the exemplary embodiment described herein employs ERC-20 and the Ethereum blockchain, it should be appreciated that other standards like ERC-1155 or similar, on another private or public blockchain, might also be used as a base for implementing the Krypto coin.

As shown in FIG. 4B, the additional properties that provide the authenticity of a Krypto coin, compared to a standard ERC-20 coin, are new members: business ID, prices[ ], hosts[ ], totalFunded, and totalRounds; and new methods: priceAt( ), hostAt( ), raiseFund( ), and fundReceived( ). The details of each are explained below.

Business ID is the token address of the BID token of the business that issues the coin. By reading this information (or value), one can read all (public) information about the business and verify its legitimacy with the registration authority. More on this verification process will be discussed in a later section.

A list, or an array, named prices[ ] is a list of unsigned numbers where each member is the price of the coin at a specific funding round.

A list, or an array, named hosts[ ] is a list of wallet addresses where each member of the list is an address of an authorized wallet (or host). An authorized wallet is a crypto wallet (e.g., of one of the owners) that is allowed to receive funds from investors for a specific funding round.

A number, called_totalRounds, is the number of total funding rounds that have been run.

A number called_totalFunded is the total funding amount that has been funded by the investors.

A method named priceAt( ) receives a round number as a parameter. It returns the price of the Krypto coin at a specific funding round.

A method named hostAt( ) receives a round number as a parameter. It returns the host (or the authorized wallet) address at a specific funding round.

A method named raiseFund( ) is used to start a funding round. It receives three parameters: the address of the host for this round, the number of funds expected to raise, and the number of tokens being offered.

And a method named fundReceived( ) is called when a fund has been received from an investor. It has two parameters: the address of the crypto wallet sending the fund and the amount of the fund.

### Operation

In the following sections, I will explain how a business owner can: (1) create their own personal ID token (PID token creation process); (2) get a registration authority to certify it and associate it with their crypto wallet (PID token registration process); (3) use the registered PID token to prove the ownership of a business, then to (3.1) create a BID token and register it with their crypto wallet (BID creation and registration process); (3.2) create a new Krypto coin for the business (Krypto coin creation process); and how the owner can use his registered PID token, BID token, and Krypto coins to (4) start a fundraising round; and (5) receive funds from investors.

Similarly, an investor can also: (1) create their own personal ID token (PID token creation process); (2) get a registration authority to certify it and associate it with their crypto wallet (PID token registration process); (3) use the registered PID token to participate in the funding processes.

### ID Token Creation, Registration, Identification and Verification

The details of all processes regarding identification (ID) tokens: creation, registration, identification, and identity verification, are described in my other patent application, Ser. No. 18/091,118, filed 2022 Dec. 29, titled “Identification token, systems and methods for identification and identity verification.” The following paragraphs in this section are intended to recap overall ideas and discuss some additional points with respect to the application of ID tokens in the processes of funding and fundraising for businesses.

In the embodiment being discussed, ID tokens of the same type (idType) are managed by one smart contract that has been deployed on the blockchain. When the smart contract is deployed, the type of ID tokens it manages is specified in the constructor of the deploying contract.

For example, creator P 40 is a Personal ID (PID) token smart contract; it manages all PID tokens whose idType is a type of personal ID (e.g., PASSPORT). And creator B 42 is a Business ID (BID) token smart contract; it manages all BID tokens whose idType is a type of business identity (e.g., BUSINESS).

While all ID tokens managed by the same smart contract have the same idType, each has a different URI (tokenURI). The tokenURI is specified not when the contract is deployed but when each token is created. It is an URL to the metadata file (e.g., in JSON format) or an entry in the metadata file that contains additional information regarding the identity that the token represents. In the case of PIDs, this information is the location (e.g., another URL) of the ID photo of the person. This ID photo is usually encrypted for privacy purposes. In the case of BIDs, the additional information may be the public information of the business (i.e., business name, owner's name, contact address, etc.).

In some embodiments, the same common URL may be used for token URIs of all tokens managed by the same contract. In such case, this same common URL, or base URL, may be specified at the time of deploying the contract in its constructor (the same way as with the idType). When each new token is created, the complete tokenURI will be formed by appending the number of the tokenId to the end of the base URL before being assigned to the token.

For example, a base URL, “https://www.kryptoid.org/passport/,” can be used for all PID tokens of creator P 40. When a new PID, with tokenId equal to, say, 1337, is created, its actual tokenURI will be automatically assigned to “https://www.kryptoid.org/passport/1337”.

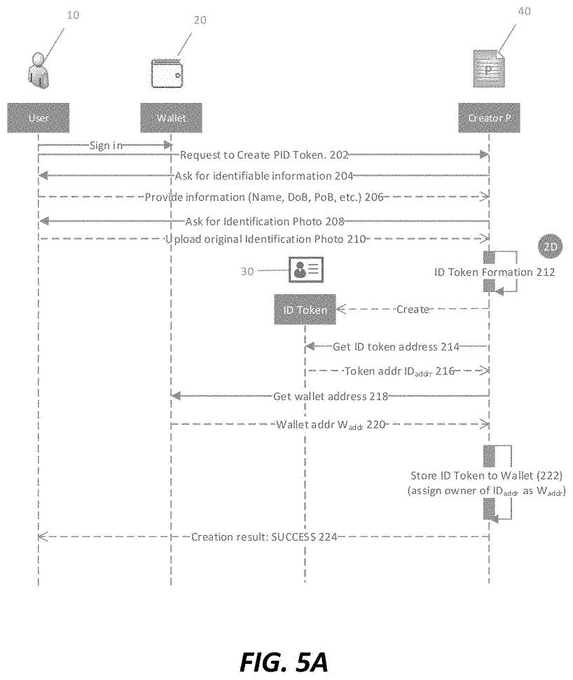

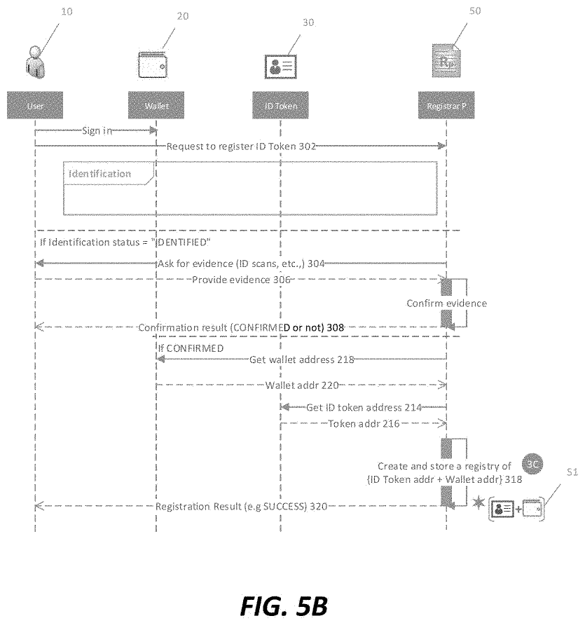

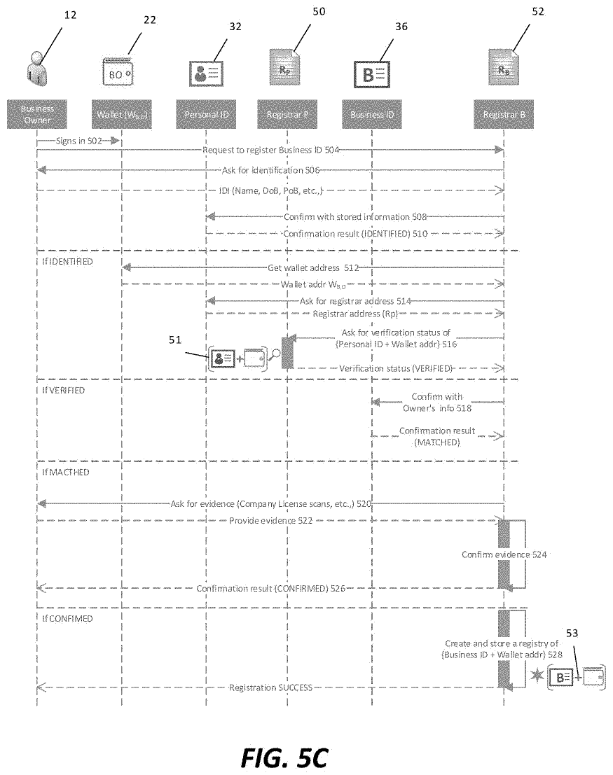

FIG. 5A is a sequence diagram depicting the process of creating a new Personal ID (PID) token. The process can be used by any user 10 (or person), whether they are a business owner or an investor.

At the end of this PID token creation process, the PID token has not yet been registered with a crypto wallet. In order to register it, as described in FIG. 5B, the owner of the PID token sends a request to a registration authority specialized in PID registration, or registrar P, identifies themselves, provides evidence (usually government-issued ID documents), and gets them verified. After the registrar has confirmed all the evidence, a new registry record to associate the PID token with the user's crypto wallet will be created on the blockchain (in some embodiments, it can be stored in the crypto wallet of the authority).

The registry record will be used in the process of identity verification every time the user needs to verify their real-life identity on the internet, especially when they want to prove their ownership over a legally registered business, as discussed in the following sections.

Note that the ID token registration process can be separated from the creation process. Meaning one ID token can be created without being registered with a particular crypto wallet. For example, the person can decide to register it later on; or the same ID token can be registered several times with different crypto wallets. This is to increase the flexibility in the usage of ID tokens; the owner can use different crypto wallets for different processes or at different times (for privacy purposes) without the need to re-creating a new ID token for each wallet.

Similar to PID tokens that are used to verify personal identities, Business Identification (BID) tokens are used to verify business identities and their ownership. When a BID token is created, not only the business information but also the personal identification information of its owner will be stored in the BID. Therefore, when creating the BID, the owner needs to provide this information together with the evidence that shows the legitimacy of the information they provide.

For the business information, the evidence can be the official registry records or company formation documents provided by the state or the government where the business was formed.

For the owner's personal identity evidence, they can also provide government-issued IDs (e.g., passport, ID card, driver's license, etc.), the same way as when they are trying to create an ID token. However, if the owner already has an ID token, they do not need to provide the evidence again, they only need to log in to the same crypto wallet that has been associated with the PID token (and has been registered by the registrar P), and their personal identity will be verified. This is indeed one of the main advantages of having ID tokens, including PID tokens, which we have been discussing.

### BID Token Registration

Once the BID token has been created by the business owner, it needs to be registered with a crypto wallet to make the wallet an “authorized holder” of the BID token.

The BID token registration process is a process of getting the business ownership certified (for example, by a registration authority) and creating a business registry record on the blockchain, which is served as a certification for this ownership.

This business registry record 53 is a matching record that matches the BID token 36 with an authorized wallet, which is the crypto wallet 22 of the business owner 12. This record 53 is served as a kind of digital certificate; it certifies that whoever controls wallet 22 is a verified owner of the business that the BID token 36 represents. The wallet 22 can now be called the “authorized holder” of the BID token 36.

(It is similar to a Personal ID token registration process where a personal registry record certifies that whoever controls wallet 22 is a verified owner of the real-life personal identity that the PID token represents. And wallet 22 is an authorized holder of the PID token).

The certification is done by a registration authority specialized in business registration, called a business registrar (or Registrar B) 52. In the process, the registrar 52: (A) confirms the business ownership by verifying all the information in the BID 36 and the PID 32 of the owner 12, certifies that the information is matched and legitimate (i.e., supported with legal evidence); then (B) creates record 53 on the blockchain.

In the first part of confirming the business ownership, the registrar 52: (1) confirms the real-life identity of owner 12; (2) confirms the real-life identity of owner 12 matches with the owner information in the B-IDI; and (3) ask the owner to provide all evidence to support their claim of ownership and confirm the evidence.

In order to confirm the real-life identity of owner 12, the registrar 52: (1. a) asks owner 12 for their personal identification information (P-IDI); (1. b) confirms this P-IDI matches with the information stored in the PID token, to make sure owner 12 is really the one they claim to be, and not impersonating someone else; and (1. c) gets the verification status of the crypto wallet 22, that owner 12 is currently using, to see if it's an authorized holder of the PID token.

Although the exemplary embodiment described herein makes use of a PID and its personal identity verification process to verify the owner's real-life identity, other ways of verification are also possible. For example, the owner can send his personal ID papers (e.g., passport, government-issued ID cards, etc.) directly to the registrar 52 to prove his identity.

In the second part of creating a business registry record 53, the registrar 52: (1) generates a registry record from the wallet address of wallet 22 and the token address of BID token 36; (2) getting a business registrar address 28 from the BID token 36 (which was assigned when the token was created); and (3) associates the registry record 53 to the business registrar address 28, thereby storing the record on the blockchain.

FIG. 5C is a sequence diagram depicting one embodiment of the process described above.

First, in step 502, the business owner 12 authenticates and signs in to their crypto wallet 22. Wallet 22 is currently holding a PID token 32 of the owner and a BID token 36 of their business.

Next, in step 504, owner 12 sends a request for BID registration to registrar B 52.

In response to the request, registrar B 52 asks the owner for the identification in step 506.

Owner 12 provides his personal identification information (P-IDI: Name, date of birth, etc.) as in the PID token identification process. This information should be identical to the one they used to create the PID token.

Registrar B 52 then confirms to see if the IDI provided by owner 12 matches with the information stored in the PID 32, for example, by calling the interface isIdentified( ) of the creator P smart contract (not shown) or calculating the ID hash from the IDI and compare it directly with the one stored in the PID 32. This is the identification process in steps 508 and 510.

If the result of the identification process (step 510) is IDENTIFIED, the process continues to verify if this identity has been verified by a registration authority.

In step 512, it gets the address of the crypto wallet 22 that owner 12 is currently signed in.

In step 514, it asks the PID 32 for its registrar address (e.g., the address of registrar P).

In step 516, registrar B 52, using the PID token address and the crypto wallet address acquired in previous steps, asks registrar P for the identity verification status of the couple: PID 32 and crypto wallet 22. This is the identity verification process. The purpose of this process is to confirm if the identity of owner 12 has been verified by a registration authority and if the wallet he is currently using is an authorized/verified one.

This step involves searching for the existence of PID registry record 51 on the blockchain. If record 51 is found, the verification status is VERIFIED. If record 51 is not found, the verification status is not VERIFIED.

If the verification status in step 516 is VERIFIED, the process continues.

In step 518, registrar B 52 confirms the P-IDI provided by owner 12 with the information stored in BID 36, for example, by comparing the name (and other personal information) of the business owner in the public metadata file of BID 36 with the IDI.

In some embodiments, this conformation may also be done by trying to compute the business identification hash from the P-IDI of the owner and the public information of the business and compare this hash with the one stored in the BID.

If the information is MATCHED, the process continues.

Next, in step 520, registrar 52 asks owner 12 to provide evidence for the ownership of the business.

Then, in step 522, owner 12 provides the evidence, for example, the official government-issued documents, business licenses, business certificates, business entity formation documents, or other kinds of legal documents, to registrar 52.

In step 524, registrar 52 confirms the evidence, makes sure that all documents are official, government-issued, and valid; and that all the information on the documents matches with the information provided by owner 12.

If all the information has been confirmed to be correct and valid, registrar 52 then moves on to the next steps.

Registrar B 52 is now certain of these things: (1) owner 12 has a real-life identity that has been verified by a registration authority; (2) this identity matches with the information stored in the BID; (3) the information in the BID has been supported with all legal evidence; and (4) the crypto wallet 22 is an authorized wallet of the PID 32.

Therefore, registrar B 52 can now also create a registry record to certify that wallet 22 is now also an authorized wallet of BID 36.

In step 528, using the address of BID token 36 and the address of wallet 22, registrar 52 creates a registry record 53 and stores it on the blockchain.

The creation of BID registry record 53 is similar to the creation of PID registry record 51, whose details are discussed in my other patent application, Ser. No. 18/091,118, filed 2022 Dec. 29, titled “Identification token, systems and methods for identification and identity verification.”

The process of BID registration has now finished successfully.

### Krypto Coin Creation

After the PID of the owner and the BID of the business have been created and registered with the authorized crypto wallet, these tokens and their registry records will be utilized to create a Krypto coin and make sure that the coin has a trusted, verified and valid information of the legally recognized business. In other words, the Krypto coin has its authenticity.

The process of creating a Krypto coin is a process comprising: (A) getting a business identifier of a business; (B) making sure this business identifier has been registered and has an authorized holder; (C) creating a fungible token and associating the business identifier with this token; and, optionally, (D) minting a certain amount of these fungible tokens to the authorized holder.

In some embodiments, instead of the business identifier, another kind of unique identifier on the blockchain (or on-chain unique identifier) can also be used to uniquely identify the business. It can be a BID token address (as we use in the displayed embodiment), a business identification hash, a registry record number, a hash, a number, a string, or any other type of identification number or token address.

In the displayed embodiment, we assume that owner 12 is the one who is sending the request to create the Krypto coin. In such case, step (B) will involve confirming that the crypto wallet 22, which is currently being used by owner 12, is the authorized holder of the business identifier (i.e., BID token 36). However, in some embodiments, when someone else is making the request, that person, or app, may specify a wallet address that will be confirmed as the authorized holder of the business identifier.

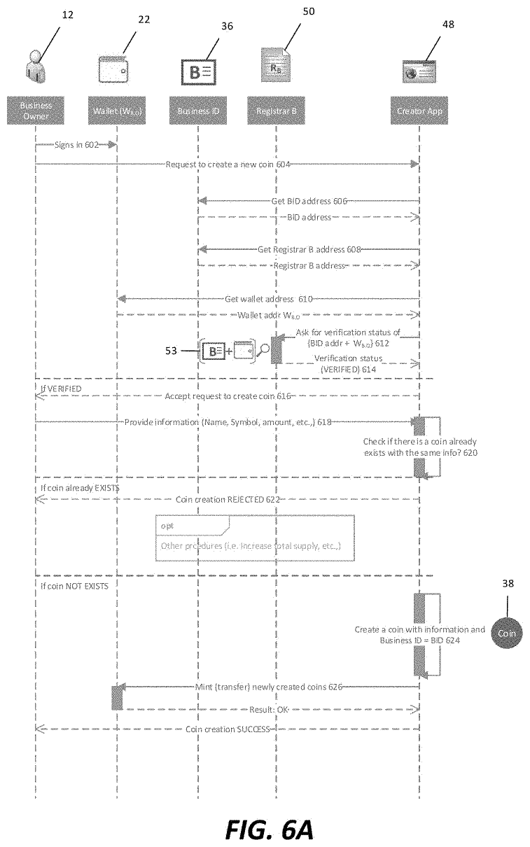

In some embodiments, before starting the process (before step (A)), the application may ask owner 12 to identify themselves and confirm this identity with the owner information stored in the BID token. However, this step can be skipped, as in the displayed embodiment in FIG. 6A, since wallet 22 of the owner will be checked in the following steps to make sure wallet 22 is an authorized holder (and the person who has access to the authorized holder must have their real-life identity verified in the BID registration process as described earlier).

The process of creating a Krypto coin is illustrated in the sequence diagram of FIG. 6A.

First, in step 602, business owner 12 authenticates and signs in to their crypto wallet 22. Wallet 22 is currently holding a BID token 36 of their business (and may also be holding a PID token 32 of the owner).

In some embodiments, wallet 22 does not necessarily hold the BID (or PID) token. Its address will be checked in the following step, and whether or not it is currently holding a PID or BID token, if there is a registry record on the blockchain certifying that it has been registered with the token (in a registration process earlier), it is qualified as an authorized holder. That is sufficient to guarantee that the person who has access to the wallet has their real-life identity verified.

Next, in step 604, owner 12 sends a request for Krypto coin creation to coin creator app 48.

In step 606, creator 48 asks for the address of BID token 36 in wallet 22. In some embodiments, where the BID token is not held in wallet 22, the owner 12 can provide this BID address directly to the creator app 48.

Having the BID token address, creator 48 asks the BID for its business registrar address in step 608. In some embodiments, a common and/or publicly known business registrar address can be used for all BID tokens on the blockchain or in a specific geographical location (such as in a state, region, or country). For example, a wallet or smart contract address owned by a public or governmental authority can be used as a business registrar address. Then, in that case, the common registrar address will be used in this step.

In step 610, creator 48 gets the address of the crypto wallet 22 that owner 12 is currently signed in.

In step 612, it asks registrar B 50 (whose address has been gotten in step 608) for the registration status of the couple: wallet 22 and BID 36.

This step involves searching for the existence of BID registry record 53 on the blockchain. If record 53 is found, the verification status is VERIFIED. If record 53 is not found, the verification status is not VERIFIED.

In step 614, if the verification status is VERIFIED, creator 48 then moves on to the next steps.

In the next step, 616, it confirms to owner 12 that it has accepted the request from the owner and asks for more information regarding the coin formation.

Owner 12 provides the requested information in step 618, such as name and symbol. This information may also include the number of coins to be initially minted, etc.

In step 620, creator 48 checks to see if a coin with the same information (i.e., name, symbol) already exists on the blockchain. If there is no coin with the same information exists, creator 48 moves on to the next steps. If there is a coin with the same name and/or symbol that already exists, creator 48 may reject the request from owner 12, quit the process (step 622) or ask owner 12 to provide different information (not shown).

Moving on, if there is no coin with the same information exists, in step 624, creator 48 creates a new Krypto coin 38 on the blockchain, following the design described earlier (in FIG. 4B), assigning the Business ID of the coin with the address of the BID 36.

Next, in step 626, creator 48 may mint a certain number of coins to wallet 22 (if the amount has been specified by the owner 12), finishing the process of Krypto coin creation.

### Fundraising

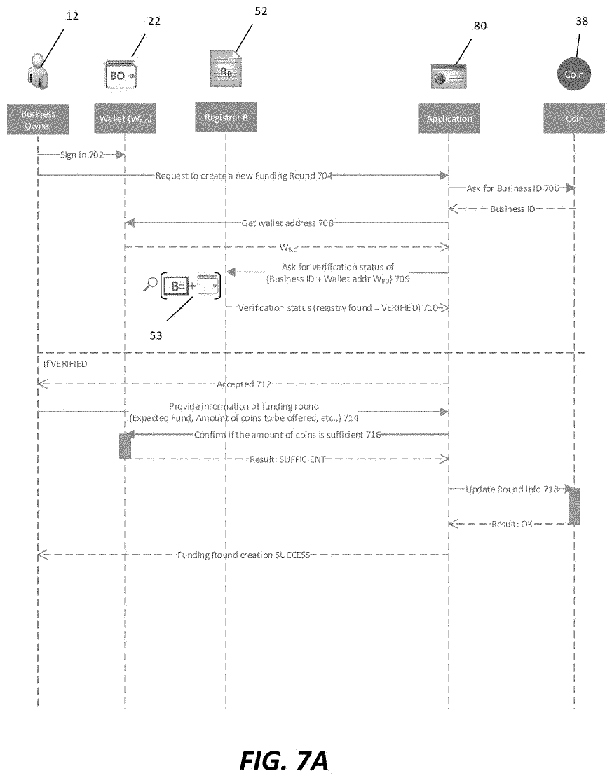

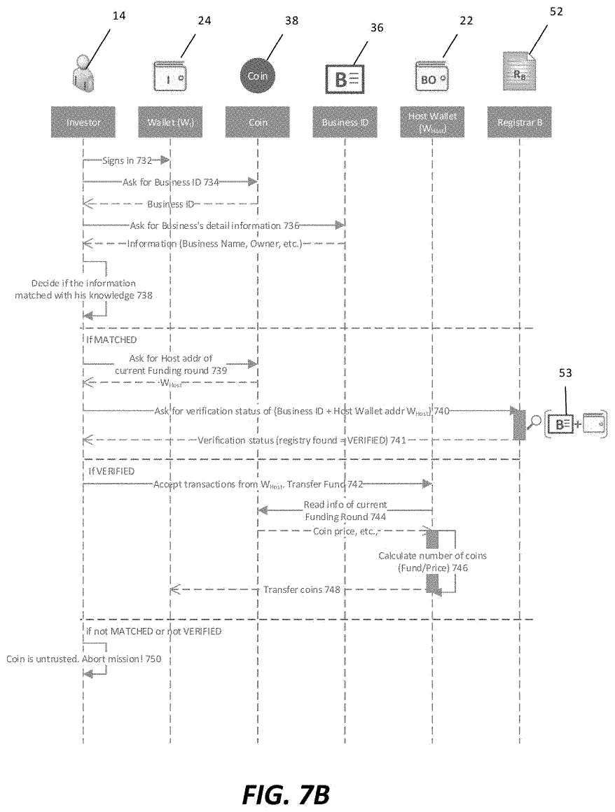

FIG. 7A is a sequence diagram depicting a fundraising process with Krypto coins.

The fundraising process is related to the following use-case (in FIG. 2): (4.1) “Create a funding round” for business owners.

In the displayed embodiment, the funding process, utilizing a Krypto coin, is handled by an application when it has received a request from the business owner. The process involves (A) getting a business identifier associated with the Krypto coin; (B) confirming a hosted wallet is the authorized wallet to receive investment funds by getting the verification status of this host wallet with the business identifier; (C) getting other information about the funding round from the owner; and (D) updating the funding round information to the Krypto coin.

In some embodiments, instead of the business identifier, another kind of unique identifier on the blockchain (or on-chain unique identifier) can also be obtained in step (A). It can be a BID token address (as we use in the displayed embodiment), a business identification hash, a registry record number, a hash, a number, a string, or any other type of identification number or token address.

In some embodiments, step (A) may involve getting the unique identifier of the Krypto coin itself. In this case, step (B) may involve getting the verification status of this host wallet with the coin and not with the business identifier.

In the displayed embodiment, the host wallet 22H is wallet 22 that owner 12 is currently using. However, in some embodiments, it may be another wallet that owner 12 specifies.

First, in step 702, business owner 12 authenticates and signs in to their crypto wallet 22. The wallet 22 may or may not currently be holding a PID token 32 and/or a BID token 36.

Next, in step 704, owner 12 sends a request to application (or app) 80 to create a new funding round.

In step 706, app 80 reads Business ID information from the Krypto coin 38. And in step 708, it gets the address of wallet 22.

Next, using Business ID, which is the token address of BID 36 (not shown), app 80 asks BID 36 for the address of its registrar B 52 (this step is not shown). App 80 then asks registrar 52 for the registration status of the couple: wallet 22 and Business ID (BID 36), in step 709.

This step involves searching for the existence of BID registry record 53 on the blockchain. If record 53 is found, the verification status is VERIFIED. If record 53 is not found, the verification status is not VERIFIED.

In step 710, if the verification status is VERIFIED, app 80 then moves on to the next steps.

In the next step, 712, it confirms to owner 12 that it has accepted the request from the owner and asks for more information regarding the fundraising round.

Owner 12 provides the requested information, in step 714, such as Expected funding to receive, amount of coins being offered, timing, etc.

In step 716, app 80 checks with wallet 22 to see how many Krypto coins it is currently holding and if it is sufficient to offer in this round. If there are not enough coins in wallet 22, app 80 may ask owner 12 to revise the information or ask their permission to mint new coins to wallet 22.

If there are enough coins available in wallet 22, in step 718, app 80 creates a new funding round and updates related information to coin 38, using its methods as described earlier (FIG. 4B).

In this step, the raiseFund( ) method will be used, provided with the following parameters: (1) a host, which is the address of the crypto wallet that is receiving funds, or wallet 22, (2) the expected value of the fund to receive (e.g., in ETH currency), and (3) number of coins to offer. A new entry for hosts[ ] and price[ ] will also be added based on the provided information.

Now, by reading the information (e.g., prices[ ], hosts[ ], etc.) from coin 38, investors can know what the current price that the coins are being offered is and which crypto wallet address is the authorized destination to send the funds.

Alternatively, owner 12 may also specify a different crypto wallet 22H address as a host (not shown) for a certain funding round. This wallet 22H can be different from wallet 22, which they are currently signed in. In such case, before updating the round info to coin 38, app 80 will ask registrar 52 for the registration status of the new couple: Business ID (BID 36) and wallet 22H. If there is a registry record 53H (not shown) exists, that means wallet 22H is also one of the authorized wallets, and it belongs to the same legitimate owner 12 (who evidently registered wallet 22H in the BID registration process).

### Funding

FIG. 7B is a sequence diagram depicting a funding process with Krypto coins.

The funding process related to the following use-cases (in FIG. 2): (5.1) “Check coin's validity,” (5.2) “Send fund,” and (5.3) “Receive coins” for investors; and (4.2) “Receive fund,” and (4.3) “Send coins” for business owners.

Coin 38 was supposedly issued by business 18, which investor 14 is considering investing in. To make sure coin 38 indeed belongs to business 18 (to safely invest, avoid being scammed, etc.), investor 14 follows the process described in this section.

The funding process with Krypto coins is a process that comprises the following: (A) getting a business identifier associated with the Krypto coin; (B) confirming the business information associated with the identifier is accurate and matches with the investor's knowledge; (C) getting, from the Krypto coin, a host wallet address that is designated to receive investment funds for a current funding round; (D) confirming that the hosted wallet is an authorized one; (E) sending an investment fund to this host wallet; and (F) receiving Krypto coins.

First, in step 732, investor 14 authenticates and signs in to their crypto wallet 24. The wallet 24 may or may not currently be holding a PID token 34 of the investor.

Next, in step 734, investor 14 asks coin 38 (read its information) for the business ID.

In step 736, using the business ID (which is the address of BID 36), investor 14 asks BID 36 for detailed information about the business. For example, investor 14 can read the information contained in the metadata file of BID 36.

Next, in step 738, investor 14 confirms if the information linked to the BID 36 matches with the information and the knowledge they have about the business 18 that they want to invest in. Investor 14 continues with the process only when the information has been confirmed MATCHED.

Next, if the information is MATCHED, in step 739, investor 14 asks coin 38 (read its information) for the host address 22 (or 22H) of the current funding round.

In step 740, investor 14 asks registrar B 52 for the registration status of the couple: the host address 22 (or 22H) and Business ID (BID 36).

Investor 14 knows the address of registrar 52 by reading the information from BID 36. In some embodiments, a common and/or publicly known business registrar address can be used for all BID tokens on the blockchain or in a specific geographical location (such as in a state, region, or country). For example, a wallet or smart contract address owned by a public or governmental authority can be used as a business registrar address. Then, in that case, the common registrar address will be used in step 740.

This step involves searching for the existence of BID registry record 53 (or 53H) on the blockchain. If the record 53 (or 53H) is found, the verification status is VERIFIED. If the record 53 (or 53H) is not found, the verification status is not VERIFIED.

In step 741, if the verification status is VERIFIED, investor 14 then moves on to the next steps.

Now investor 14 can be certain that host 22 (or 22H) is an authorized wallet belonging to owner 12, to which they can safely transfer the funds. Investor 14 transfers the desired amount of funds to host 22 (22H) in step 742.

In the embodiment shown in FIG. 7B, the host 22 (22H) also acts as an application. In the next step, step 744, after receiving the funds from investor 14, host 22 (or 22H) reads the information regarding the current funding round from coin 38 to get the coin price, etc.

In step 746, host 22 (22H) then calculates the number of coins it needs to send back to investor 14 (e.g., from the number of funds it received, subtracting the transaction fees, divided by the current price, etc.).

Then wallet 22 (22H) transfers the calculated number of coins back to wallet 24 of investor 14 in step 748, finishing the funding process.

In some embodiments, the handling of calculation and sending coins may be done by app 80 of the platform. In that case, after receiving funds from investor 14 (in step 742), host wallet 22 (22H) can automatically, or manually by owner 12, send a request to release coins to app 80 (not shown). App 80 then calculates the number of coins and makes a transfer of those coins from wallet 22 (22H) of owner 12 to wallet 24 of investor 14 (similar to steps 746-748 described earlier).

If otherwise, the business information in step 738 is not MATCHED with the investor's knowledge or the verification status in step 741 is not VERIFIED, meaning the coin 38 is untrusted, investor 14 should abort the funding attempt, as in step 750.

### Examples of App Implementation

FIGS. 8-1A to 8-4B show the user interface (UI) of an exemplary front-end application (or app) for the system of fundraising and funding with non-fungible tokens with authenticity (PID token, BID token) and fungible tokens with authenticity (Krypto coin). This app interacts with back-end smart contracts of PID, BID, Krypto coin, and Registrars that have been deployed on a blockchain (whose UIs are not visible to end users and not shown).

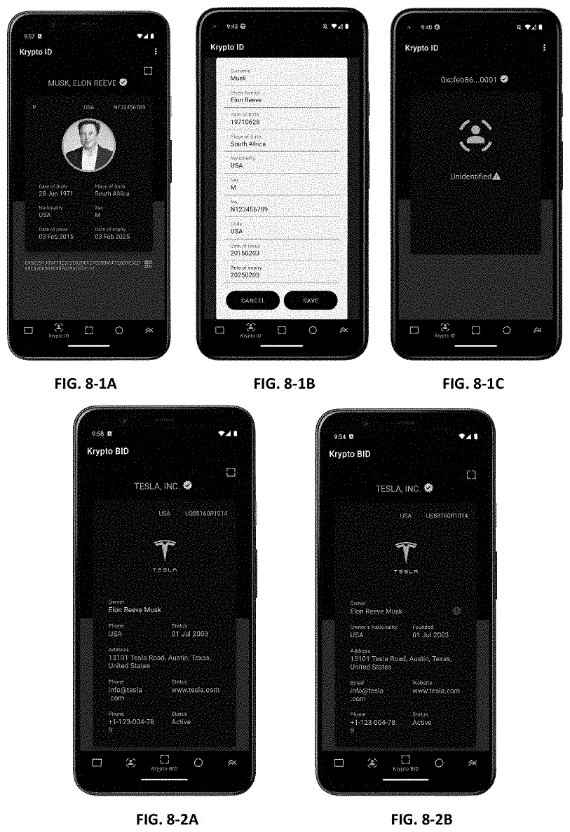

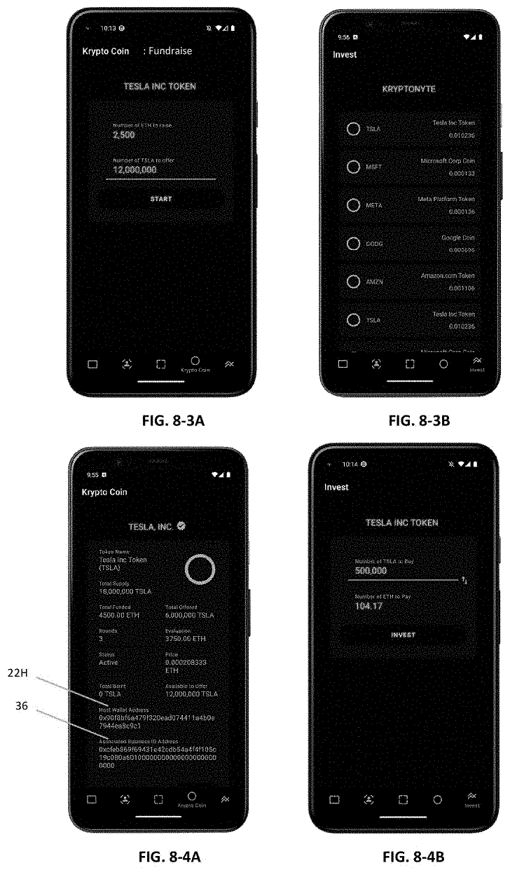

FIG. 8-1A is an example of information stored in a PID token 32 of a business owner. This information can be shown visibly on the app's UI if the owner has provided their P-IDI correctly (meaning, the identification (ID) hash computed from the P-IDI matches with the ID hash in the PID token).

The owner can provide this P-IDI by filling in a form, as shown in FIG. 8-1B.

If the P-IDI provided by the owner does not match with the ID hash stored in the PID token, even though the owner may possess the token in their wallet now, it still shows on the UI that the owner hasn't correctly identified themselves (aka. UNIDENTIFIED) as shown in FIG. 8-1C.

Note that in FIG. 8-1C, the green checkmark stills appears on the top of the screen. This checkmark means the PID token (that is currently being held in the wallet of the owner) has been registered with the holding wallet (thus, it is VERIFIED). In other words, the wallet has been verified to be the authorized holder of this PID token.

FIG. 8-2A is an example of information stored in a BID token 36 of a business owner. The information of the owner of the business appears on the first line, under the logo. The green color of the owner's name means that this information matches with the P-IDI provided by the owner (screen in FIG. 8-1B above) and the information in the PID token (FIG. 8-1A). If otherwise, the information does not match, an error mark will display next to the name of the owner, and the name is not green anymore, as can be seen in FIG. 8-2B.

In FIGS. 2A and 2B, we also see a green checkmark appears next to the name of the company at the top of the screens. This checkmark has the same meaning as the one in the screens for the PID token (FIGS. 8-1A and 8-1C); it means that the BID token has been verified with the current holding wallet or the wallet of the owner.). In other words, the wallet has been verified to be the authorized holder of this BID token.

In such a case (the current wallet and the BID token have been verified together), the features of creating a Krypto coin and raising funds will be available to the owner.

FIG. 8-3A is a screen for the fundraising process. In this screen, a business owner can specify an expected amount of funds (e.g., in ETH currency) to raise, and a number of Krypto coins are being offered in exchange. After the owner clicks the Start button, the process of fundraising, as described in the section above, will be started.

FIGS. 8-3B, 8-4A, and 8-4B illustrate the use cases of the funding process described above.

FIG. 8-3B shows a list of Krypto coins belonging to legally recognized businesses that an investor can invest in. When a coin is selected, the app brings the user (investor) to a new screen, shown in FIG. 8-4A.

In FIG. 8-4A, the detailed information regarding the business (e.g., “Tesla, Inc.” in the example) associated with the Krypto coin (e.g., TSLA coin, named “Tesla Inc Token”) is displayed. The investor can check if the information matches his knowledge about the business. The investor can also see other information related to the coin: total supply, totally funded amount, number of funding rounds, etc., and information related to the current funding round, such as price, how many coins are being offered (e.g., 12,000,000 TSLA in this example), the current host address (22H), etc. The Business ID (the address of BID token 36) associated with the coin is also being displayed for the convenience of the investor.

The verification status of the coin, meaning the verification status of the BID and the host associated with the coin, is represented by the green checkmark next to the name of the business, at the top of the screen, in FIG. 8-4A. This is automatically checked by the application with the registrar B. The visual indication, with the green checkmark, helps the investor quickly and conveniently confirm the status of the business and the coin.

If the verification status of the coin is not VERIFIED, a red warning mark may appear (not shown).

If the investor decides to invest in the business, the application will show the next screen, as shown in FIG. 8-4B, where the investor can specify either the fund (e.g., in ETH) they want to spend or the number of coins (e.g., TSLA) they want to receive, the application will automatically calculate the other value, based on the current price and the transaction fees, etc.

When the investor clicks the “Invest” button, the entered amount of funds will send to the host address, as described in the sequence in FIG. 7B.

### Additional Embodiments

Based on the disclosure and teachings provided herein, a person of ordinary skill in the art will appreciate other ways and/or methods to implement the various embodiments and that many modifications and variations are possible, for example, in some embodiments:
When the fund is transferred by an investor to the authorized wallet or the wallet designated to that funding round, the coins can be released to the investor automatically without requiring any manual actions from the business owner. However, the system can also be set up in a way that manual interaction from the owner is needed before sending the coins. This can be beneficial in a way that it provides more control to the owner while the other way provides flexibility to the system and timing benefits to the investor.
In a BID token, one owner's name or the names of all the owners can be specified. However, at one time, one of the owners may register the BID token with his wallet. If other owners want to register the BID token with their wallets, they have to go through the same registration process.
There may be some cases in that not all the owners of the company/business are authorized to raise funds and/or release coins. In such cases, the business has to provide related document(s) that authorize which one of the owners is the authorized one and is allowed to register the BID token. And the one designated as the authorized owner has to submit this document together with other documents to the registrar in order to register the BID token with his crypto wallet.
More information can be stored in the Krypto coin, such as information related to the financials of the business (i.e., history of transactions from the host wallets, history of prices over time, balances of current holders, other statistic information, etc.)
The business ID stored in the Krypto coin may not be the token address of the BID token but the ID hash (the property stored inside the BID token, which was created from the business identification information) itself.
The wallet address of the authorized owner of the business (wallet 22) can also be permanently stored as one of the properties of the Krypto coin at the time of its creation.
The registrars responsible for registering PID tokens (registrar P) and BID tokens (registrar B) can be the same or separated.
The calculation of registry records can be a different hash function or another computation that provides the same characteristics as hash functions.
The cryptographic hash functions can be based on a different standard or algorithm. For example, it can be based on one of the algorithms, including, but not limited to, SHA-2 (i.e., SHA-224, SHA-256, SHA-384, SHA-512, SHA-512/224 and SHA-512/256) or SHA-3 (i.e., SHA3-224, SHA3-256, SHA3-384, SHA3-512, SHAKE128, and SHAKE256), or any variation and/or combination thereof.
The type of ID tokens (PID and BID) may or may not be publicly readable.
When creating a new ID token, the creator smart contract or the user can select the value for the ID type from a set of predefined values, or the type can be calculated and decided upon based on the fields of identification information provided by the user.
The ID type can be a 256-bit value or any N-bit value (with N can be any number, i.e., 128, 10, 50, 100 . . . ).
One ID token may have more than one ID type, and each type may be associated with one ID hash.
There may be more than one ID hash in an ID token. For example, ID hash2 can be produced from some of the fields of information while ID hash is still the main one. Each hash value can be used in different contexts to increase the flexibility of the ID token.
The creator smart contract may check the existence of the identification hash (ID hash) before creating the ID token. It may choose not to create the ID token if the same ID hash already exists to make sure there is not more than one ID token sharing the same ID hash on the blockchain.
The address of the registrar in the ID token may or may not be publicly readable. It may be accessed by the parties with authorized permissions only.
The registrar address in an ID token may be made mutable to provide flexibility. It may be changed and updated to a new registrar. A new registration may be needed with this new registrar.
The registrar address stored in the ID token may not point to a crypto wallet but instead to a smart contract that belongs to the registration authority or the registrar. This contract may provide extra functionalities.
The registration authority may not be the same authority that provided and certified the traditional papers. They can be other trusted parties who are qualified to confirm the evidence with accuracy and trusted by the public.
The metadata file of a PID token can store some other information, such as, for example, a link to an ID photo, whether it is encrypted or not encrypted, and/or the checksum of the photo, and/or some public information of a person's identity (such as name, nationality, etc.), and/or their public key, and/or their email address and so on.
Some non-private fields of information (for example, “COUNTRY”) can be made publicly readable in the PID token for the same purpose of increasing flexibility.
Similarly, the metadata file of a BID token can also store some other information.
The token address of the ID token may have a different length rather than 32 bytes.
The ID token address can take a different form rather than a hexadecimal string and can be computed by a different method as long as it produces the same characteristics and is uniquely representative of the token on the blockchain.
When storing a newly created ID token on a blockchain, the creator app can choose to store the ID token in another wallet rather than the wallet of the user.
In the BID registration process, the registrar B can ask the owner to provide evidence by uploading scanned versions of the legal documents, or it can use any other method, such as manually confirming the documents on-site, etc.
The registrar or the registration authority may be able to modify (update or remove) a record that has been registered on the blockchain.
The registry record or digital certificate token may be made transferable and can be transferred to another wallet of the same registration authority or to another authority.
The creator and the registrar can be the same smart contract.
The user can use any method to prove their ownership of the crypto wallet, either by signing in to it (with a method like Sign In With Ethereum) or any other way, such as doing some transactions from the wallet.
The system and ID token can be deployed on a different blockchain rather than Ethereum to increase efficiency and compatibility and/or to reduce gas fees.
The registry record can be formed directly from the wallet address and the identification hash without using the token address.

### CONCLUSION

Through understanding the process described herein, the reader will see that at least one embodiment of the fungible and non-fungible tokens with authenticity provides a better system and methods for businesses to raise funding and investors to invest in the businesses. Since there are direct links between digital tokens on the blockchain and the real-life identities of people and businesses, which are easily and readily verifiable by everyone, it helps provide transparency and safety to the investing industry. Furthermore, the system is particularly beneficial for investors, especially inexperienced ones. They can rely on the verification process, which is automatic and secured by blockchain technology, rather than their skills, experiences, or the availability of information, which are usually limited, less reliable, or prone to human errors.

While the above description contains many specificities, these should not be construed as limitations of the scope of this disclosure but rather as an exemplification of several embodiments thereof.

Some portions of this description describe the embodiments of the present disclosure in terms of algorithms. These operations, while described functionally, computationally, or logically, are understood to be implemented by computer programs or equivalent electrical circuits, micro-code, or the like. The described operations may be embodied in software, firmware, hardware, or any combination thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the present disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer-readable storage medium or any type of media suitable for storing electronic instructions, which may be coupled to a computer system bus. Furthermore, any computing systems referred to herein may include a single processor or may be implemented with architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer-readable storage medium and may include any embodiment of a computer program product or other data combination described herein.

Embodiments can utilize at least one network that would be familiar to those skilled in the art of supporting communications using any of a variety of commercially available protocols, such as TCP/IP, FTP, UPnP, NFS, and CIFS. The network can be, for example, Local Area Network (LAN), Wide Area Network (WAN), a Virtual Private Network (VPN), the Internet, an intranet, an extranet, a peer-to-peer network, a publicly switched telephone network, an infrared network, a wireless network, or any combination thereof.

Embodiments of the present disclosure may also be practiced in distributed computing environments where tasks or modules are performed by remote processing devices, which are linked through a communications network, such as a LAN, WAN, or the Internet. In a distributed computing environment, program modules or subroutines may be located in both local and remote memory storage devices. Those skilled in the relevant art will recognize that portions of the described technology may reside on a server computer while corresponding portions reside on a client computer (e.g., PC, mobile computer, tablet, or smartphone). Data structures and transmission of data particular to aspects of the technology are also encompassed within the scope of the described technology.

Embodiments of the present disclosure may utilize public or private blockchain infrastructures, distributed ledgers, append-only databases, and the like.

In embodiments utilizing a Web server, the Web server can run any of a variety of server or mid-tier applications, including, but not limited to, HTTP servers, FTP servers, CGI servers, JSON servers, data servers, Java servers, and business application servers. The server(s) may also be capable of executing programs or scripts in response to requests from user devices, such as by executing one or more Web applications that may be implemented as one or more scripts or programs written in any programming language, such as Java®, C, C# or C++ or any scripting language, such as Perl, Python, or TCL, as well as combinations thereof. The server(s) may also include database servers, including, without limitation, those commercially available from Oracle®, Microsoft®, and IBM®.

The environment can include a variety of data stores and other memory and storage media, as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element, or keypad) and at least one output device (e.g., a display screen, a display device, printer, or speaker). Such a system may also include one or more storage devices, such as disk drives, optical storage devices, and solid-state storage devices such as random access memory (RAM) or read-only memory (ROM), as well as removable media devices, memory cards, flashcards, etc.

Such devices can also include a computer-readable storage media reader, a communications device (e.g., a modem, a network card (wireless or wired), an infrared communication device), and working memory, as described above. The computer-readable storage media reader can be connected with, or configured to receive, a computer-readable storage medium representing remote, local, fixed, and/or removable storage devices as well as storage media for temporarily and/or more permanently containing, storing, transmitting, and retrieving computer-readable information. The system and various devices also can include a number of software applications, modules, services, or other elements located within at least one working memory device, including an operating system and application programs such as a client application or Web browser. It should be appreciated that alternate embodiment may have numerous variations from that described above. For example, customized hardware might also be used, and/or particular elements might be implemented in hardware, software (including portable software, such as applets, APIs, scripts, and the like), or both. Further, connection to other computing devices, such as network input/output devices, may be employed.

Storage media and other non-transitory computer-readable media for containing code, or portions of code, can include any appropriate media known or used in the art, such as but not limited to volatile and non-volatile, removable and non-removable media implemented in any method or technology for storage of information such as computer-readable instructions, data structures, program modules or other data, including RAM, ROM, EEPROM, flash memory or other memory technology, CD-ROM, digital versatile disk (DVD), or other optical storage, magnetic cassettes, magnetic tape, magnetic disk storage, or other magnetic storage devices, or any other medium which can be used to store the desired information and which can be accessed by a system device.

The foregoing description of the embodiments of the present disclosure has been presented for the purpose of illustration; it is not intended to be exhaustive or to limit the invention to the precise forms disclosed. The description and drawings are, accordingly, to be regarded in an illustrative rather than a restrictive sense. The language used in the specification has been principally selected for readability and instructional purposes. It is therefore intended that the scope of the invention be limited not by this detailed description and drawings but rather by any claims that issue based on this application. It will, however, be evident that various modifications and changes may be made thereunto without departing from the broader spirit and scope of the invention as set forth in the claims.

1. A method for registering a business identification (BID) token on a blockchain, comprising:
a. confirming business ownership of an individual over a business wherein said BID token represents said business, and said individual had authorized access to a crypto wallet; and
b. storing a business registry record of said crypto wallet and said BID token on blockchain;
whereby said business registry record can be used as a digital certificate of the ownership of said individual over said business.

2. The method of claim 1, said step of confirming business ownership comprises:
a. verifying the real-life identity of said individual;
b. confirming said real-life identity matches with information of the business owner in said BID token; and
c. confirming evidence of business ownership of said individual over said business;
whereby said individual has been verified to be the legitimate owner of said business.

3. The method of claim 2, wherein said step of verifying the real-life identity comprises:
a. getting a personal identification information (P-IDI) of said individual;
b. confirming said P-IDI matches with information stored in a personal identification (PID) token wherein said crypto wallet is holding said PID token; and
c. getting verification status of said crypto wallet with said PID token, thereby confirming said crypto wallet has been verified by a registration authority as an authorized holder of said PID token;
whereby the real life identity of said individual has been verified by said registration authority.

4. The method of claim 3, wherein said step of getting verification status comprises:
a. getting a personal registrar address associated with said PID token; and
b. asking the registrar at said personal registrar address to look for the existence of a personal registry record wherein said personal registry record is formed from said crypto wallet address and said PID token address;
whereby the verification status of said crypto wallet with said PID token is determined.

5. The method of claim 1, wherein said step of storing a business registry record comprises:
a. generating a registry hash from a wallet address of said crypto wallet and a token address of said BID token;
b. getting a business registrar address associated with said BID token; and
c. associating said registry hash to said business registrar address;
whereby said registry hash uniquely represents the matching between said crypto wallet and said BID token.

6. A method for creating Krypto coins, comprising:
a. getting an on-chain unique identifier of a business;
b. confirming that said on-chain unique identifier has been registered with a crypto wallet; and
c. minting at least one fungible token on blockchain and associating said on-chain unique identifier with said fungible token;
whereby said fungible token now has an authenticity that uniquely represents said business.

7. The method of claim 6, wherein said on-chain unique identifier is selected from a group consisting of a business identifier, a business identification token address, a business identification number, a business identification hash, a business registry record number, a registry number, an identification number, a hash, a number, a string, an identification token address, a token address, and a non-fungible token address.

8. The method of claim 6, wherein an individual had authorized access to said crypto wallet.

9. The method of claim 6, wherein said step of confirming comprises:
a. getting a wallet address of a crypto wallet wherein an individual had authorized access to said crypto wallet;
b. getting a business registrar address; and
c. asking the registrar at said business registrar address to look for the existence of a business registry record wherein said business registry record is formed from said wallet address and said on-chain unique identifier;
whereby the verification status of said crypto wallet with said on-chain unique identifier is determined.

10. The method of claim 9, wherein said on-chain unique identifier is a BID token address of a BID token wherein said crypto wallet is holding said BID token and said business registrar address is associated with said BID token.

11. The method of claim 9, wherein said on-chain unique identifier is a BID token address of a BID token wherein said individual provides said BID token address and said business registrar address is associated with said BID token.

12. The method of claim 9, wherein said business registrar address is selected from a group consisting of a smart contract address, a crypto wallet address, and a unique identifier on a blockchain.

13. A method for fundraising with Krypto coin, comprising:
a. getting an on-chain unique identifier associated with said Krypto coin;
b. getting verification status of a crypto wallet with said on-chain unique identifier;
c. getting information for a new funding round from said individual; and
d. updating said information to said Krypto coin;
whereby said Krypto coin now has said information as information for the new funding round.

14. The method of claim 13, wherein said on-chain unique identifier is selected from a group consisting of a business identifier, a business identification token address, a business identification number, a business registry record number, a registry number, an identification number, an identification token address, a Krypto coin address, a smart contract address, a token address, a non-fungible token address, and a fungible token address.

15. The method of claim 13, wherein an individual has specified an address for said crypto wallet.

16. The method of claim 13, wherein said step of getting verification status comprises:
a. getting a wallet address of a crypto wallet wherein an individual had authorized access to said crypto wallet;
b. getting a business registrar address; and
c. asking the registrar at said business registrar address to look for the existence of a business registry record wherein said business registry record is formed from said wallet address and said on-chain unique identifier;
whereby the verification status of said crypto wallet with said on-chain unique identifier is determined.

17. The method of claim 16, wherein said on-chain unique identifier is a BID token address of a BID token and said business registrar address is associated with said BID token.

18. The method of claim 16, wherein said information for a new funding round includes: a host wallet address, an expected funding amount, a number of coins to offer.

19. A method for funding with Krypto coin, comprising:
a. getting a business identifier associated with said Krypto coin;
b. confirming business information associated with said business identifier;
c. getting a host address of a host wallet wherein said host wallet is designated to receive investment funds for a current funding round of said Krypto coin;
d. getting verification status of said host wallet with said business identifier;
e. transferring an investment fund to said host address; and
f. receiving Krypto coins;
whereby a secure funding process has been conducted with a legitimate owner of said business, and said owner is authorized to receive the fund.

20. The method of claim 19, wherein said step of getting verification status comprises:
a. getting a business registrar address; and
b. asking the registrar at said business registrar address to look for the existence of a business registry record wherein said business registry record is formed from said host address and said business identifier;
whereby said host wallet has been confirmed to be trustworthy to send an investment fund to.

21. The method of claim 20, wherein said business identifier is a BID token address of a BID token and said business registrar address is associated with said BID token.

22. A tangible, computer-readable medium in which is non-transitorily stored computer program code that, when executed by a computer processor, causes performance of a method for funding with Krypto coin, the method comprising:
a. getting a business identifier associated with said Krypto coin;
b. confirming business information associated with said business identifier;
c. getting a host address of a host wallet wherein said host wallet is designated to receive investment funds for a current funding round of said Krypto coin;
d. getting a business registrar address;
e. asking the registrar at said business registrar address to look for the existence of a business registry record wherein said business registry record is formed from said host address and said business identifier;
f. transferring an investment fund to said host address; and
g. receiving Krypto coins;
whereby a secure funding process has been conducted with a legitimate owner of said business, and said owner is authorized to receive the fund.
